(19) United States
(12) Patent Application Publication
(10) Pub. No.: US 2011/0112861 A1
(43) Pub. Date: May 12, 2011

(54) CALORIE CONSUMPTION ASSISTANCE SYSTEM, CALORIE CONSUMPTION ASSISTANCE PROGRAM AND RECORDING MEDIUM

(76) Inventor: Nobuhiro Hama, Osaka (JP)

(21) Appl. No.: 13/054,006

(22) PCT Filed: Jul. 16, 2009
(86) PCT No.: PCT/JP2009/062905

§ 371 Date: Jan. 13, 2011

(30) Foreign Application Priority Data
Jul. 17, 2008 (JP) 2008-185827

(51) Int. Cl. G06Q 50/00; G06Q 10/00

(52) U.S. Cl. 705/2

(57) ABSTRACT

The present invention provides a calorie consumption assistance system for assisting user's calorie consumption so that the user's calorie consumption in a certain time period can more efficiently reach a target amount. A calorie consumption assistance system (1) according to the present invention includes an information terminal device (2) including calorie consumption amount determining means for determining a calorie consumption amount consumed by a user in a certain period and target amount deciding means for deciding a target amount of calorie consumption in the certain time period; a sever device (4) including content selecting means for selecting an exercise assistance content suitable for a difference between the calorie consumption amount thus determined and the target amount thus decided; and a display device (3) including display means for displaying the exercise assistance content thus selected.

### TECHNICAL FIELD

The present invention relates to a calorie consumption assistance system, a calorie consumption assistance program and a recording medium in which the calorie consumption assistance program is stored, each of the calorie consumption assistance system, the calorie consumption assistance program and the recording medium assisting a user to consume calorie, so that the user's calorie consumption in a certain time period reaches a target amount.

### BACKGROUND ART

In compliance with specific health examination and specific heath guidance from April 2008, corporate health insurance association etc. have a duty to carry out medical checkup and guidance on metabolic syndrome (visceral adiposity syndrome) to health insurance insurers aged from 40 to 74 years old. As such, people are getting more keen on health promotion and obesity prevention recently.

Life-style diseases such as diabetes, hyperpiesia, etc., which are recently increasing, attribute to accumulation of visceral fat. It is generally recognized that moderate exercise and balanced diet are essential to prevention of these life-style diseases.

While the social background mentioned above also encourages habitual exercise to the society, more users are walking for exercise with pedometer, exercise amount meter, or the like. The users set target calorie consumption or a target number of steps (for example, 10,000 steps per day). However, setting such a target calorie consumption does not guide the users how to achieve the target calorie consumption. Meanwhile, external factors such as office works and commuting on drive deprive the users of opportunities to exercise or walk. As a result, a majority of the users fails to achieve the target calorie consumption or target number of steps, thereby habitually falling into short of exercise.

In view of this problem, Patent Literature 1 discloses a routing assistance device for assisting a user to achieve a target calorie consumption. For the user, the device carries out path search to find a path in consideration of information necessary for user's health management, and carries out routing assistance to guide the user according to the path.

Further, Patent Literature 2 discloses a walking schedule management system, which counts the number of steps of a user so as to calculate out a deficient walking distance to achieve a target number of steps, and determines a walking schedule according to the deficient walking distance so as to provide the walking schedule to the user.

### CITATION LIST

### Patent Literatures

### Patent Literature 1

Japanese Patent Application Publication, Tokukaihei, No. 10-148539 A (Publication Date: Jun. 2, 1998)

### Patent Literature 2

Japanese Patent Application Publication, Tokukai, No. 2005-147916 A (Publication Date: Jun. 9, 2005)

### SUMMARY OF INVENTION

### Technical Problem

However, in the routing assistance device disclosed in Patent Literature 1 and the walking schedule management system disclosed in Patent Literature 2, only the increase in walking period of the user is considered as measures for causing the user to achieve the target calorie consumption. That is, in Patent Literature 1 and Patent Literature 2, the deficiency of calorie consumption to the target amount is to be solved by walking only. Thus, Patent Literature 1 and Patent Literature 2 does not provide the user with sufficiently efficient measures for calorie consumption.

The present invention was made in order to solve the aforementioned problem, and an object of the present invention is to provide a calorie consumption assistance system for assisting a user to consume calorie so that the user's calorie consumption in a certain time period reaches a target amount more efficiently.

### Solution To Problem

In order to attain the object, a calorie consumption assistance system according to the present invention includes: calorie consumption amount determining means for determining a calorie consumption amount consumed by a user in a certain period; target amount deciding means for deciding a target amount of calorie consumption in the certain time period; content selecting means for selecting an exercise assistance content suitable for a difference between the calorie consumption amount thus determined and the target amount thus decided, the exercise assistance content expressing an exercise for assisting user's calorie consumption; and display means for displaying the exercise assistance content thus selected.

In this arrangement, the calorie consumption amount determining means determines a calorie consumption amount (hereinafter, an accomplished calorie consumption amount) consumed by a user in a certain period, and the target amount deciding means decides a target amount of calorie consumption in the certain time period. The difference worked out by subtracting the accomplish calorie consumption amount from the target amount thus decided is a calorie amount that indicates how much the user's actual calorie consumption is deficient to the target amount.

Based on the difference between the calorie consumption amount and the target amount, the content selecting means selects an exercise assistance content expressing an exercise for assisting calorie consumption of the user. Further, the display means displays the exercise assistance content selected by the content selecting means.

When the user performs the exercise expressed in the exercise assistance content displayed on the display means, the use can consume calories to make up the deficiency of the calorie consumption to the target amount. As a result, the user can achieve the target amount of the calorie consumption. Moreover, the exercise assistance content expresses an exercise for assisting the user to consume calories. By performing the exercise assistance content, the user can more efficiently consume calories, compared with daily activity such as walking.

As described above, the calorie consumption assistance system according to the present invention can assist the user in his/her calorie consumption in such a way that the user can more efficiently achieve the target amount of the calorie consumption for the certain time period.

Moreover, the calorie consumption assistance system according to the present invention is preferably further configured to include: a portable terminal device; a server device; and a display device, the portable terminal device including the calorie consumption amount determining means and the target amount deciding means, the server device including the content selecting means, and the display device including the display means.

A calorie consumption assistance system with this configuration can achieve a similar effect to that of a calorie consumption assistance system with the aforementioned configuration.

Furthermore, the calorie consumption assistance system according to the present invention is preferably further configured to include: candidate content selecting means for selecting at least one exercise assistance content suitable for the difference, the at least one exercise assistance content being a candidate of the exercise assistance content that is to be selected by the content selecting means; the display means displaying each brief information of the at least one exercise assistance content selected by the candidate content selecting means, and the content selecting means selecting an exercise assistance content of brief information designated by the user from the each brief information thus displayed.

In this configuration, the candidate content selecting means for selecting at least one exercise assistance content according to the difference, the at least one exercise assistance content being a candidate of the exercise assistance content that is to be selected by the content selecting means, and the display means displays each brief information of the at least one exercise assistance content selected by the candidate content selecting means. Further, after the display of the brief information, the content selecting means selects an exercise assistance content of brief information designated by the user from the each brief information thus displayed. That is, the user can refer to the brief information displayed on the display means, so as to know about the exercise before the user performs the exercise. If there are a plurality of exercise assistance contents suitable for the difference, the user can designate an exercise assistance content the user prefers from among the plurality of exercise assistance contents because the display means displays each brief information of the plurality of exercise assistance contents.

Furthermore, the calorie consumption assistance system according to the present invention is preferably further configured such that the display means displays the calorie consumption amount of every certain time period and an assisted calorie consumption amount of every certain time period, the assisted calorie consumption amount being a calorie consumption consumed by performing the exercise assistance content selected by the content selecting means.

With this configuration, the calorie consumption amount actually consumed by the user, and the assisted calorie consumption amount that the user consumes by performing the exercise assistance content are displayed by the display means on the basis of the certain time period. By this, the user can easily check transition of the calorie consumption amount of the user for every certain time period, and the assisted calorie consumption amount.

Moreover, the calorie consumption assistance system according to the present invention is preferably further configured such that the content selecting means performing the selection of the exercise assistance content suitable for the difference by selecting, from among a plurality of exercise assistance stored in a database, the exercise assistance content in reference with each assisted calorie consumption amount of the plurality of exercise assistance content, the database storing the plurality of exercise assistance contents in association with the assisted calorie consumption amounts of the plurality of exercise assistance content, each assisted calorie consumption amount of an exercise assistance content being a calorie consumption consumed by performing the exercise assistance content.

In the above configuration, the database stores therein a plurality of exercise assistance contents in association with the assisted calorie consumption amounts of the plurality of exercise assistance content. The content selecting means can select the exercise assistance content suitable for the difference by selecting, from among the plurality of exercise assistance stored in a database, the exercise assistance content in reference with each assisted calorie consumption amount of the plurality of exercise assistance content. In other words, the content selecting means can search for an exercise assistance content suitable for the difference without performing any complicate process. Thus, it is possible to simplify the configuration of the content selecting means.

Moreover, the calorie consumption assistance system according to the present invention is preferably further configured to include body information setting means for setting body information of the user, the content selecting means performing the selection of the exercise assistance content suitable for the difference by selecting, from among a plurality of exercise assistance stored in a database, the exercise assistance content in reference with the body information of the user, intensity information of exercises of the plurality of exercise assistance contents and exercise durations of the exercises, the database storing the plurality of exercise assistance contents in association with the intensity information of exercises of the plurality of exercise assistance contents and the exercise durations of the exercises.

In the above configuration, the database stores therein the plurality of exercise assistance contents in association with the intensity information of exercises of the plurality of exercise assistance contents and the exercise durations of the exercises. The content selecting means selects the exercise assistance content suitable for the difference by selecting, from among a plurality of exercise assistance stored in a database, the exercise assistance content in reference with the body information of the user as well as the intensity information of exercises of the plurality of exercise assistance contents and the exercise durations of the exercises.

Here, in general, users with different body information such as body weights consume different amounts of calories if they perform exercises of same intensity for the same time period.

Thus, the content selecting means selects an exercise assistance content suitable for the difference, referring to the body information of the user as well. Thus, the calorie consumption assistance system can provide the user with an exercise assistance content, which is suitable for the deficiency of the calorie consumption to the target amount and for the body information of the user.

### Program And Recording Medium

The calorie consumption assistance system can be realized by way of a computer. In this case, the present invention encompasses a calorie consumption assistance program(s) for realizing the calorie consumption assistance system on a computer(s) by operating the computer(s) as the means, and a computer-readable in which the calorie consumption assistance program(s) is/are stored.

### Advantageous Effects of Invention

The calorie consumption system according to the present invention, as described above, includes: calorie consumption amount determining means for determining a calorie consumption amount consumed by a user in a certain period; target amount deciding means for deciding a target amount of calorie consumption in the certain time period; content selecting means for selecting an exercise assistance content suitable for a difference between the calorie consumption amount thus determined and the target amount thus decided, the exercise assistance content expressing an exercise for assisting user's calorie consumption; and display means for displaying the exercise assistance content thus selected.

Therefore, the calorie consumption assistance system of the present invention can assist user's calorie consumption so that the user's calorie consumption in a certain time period can more efficiently reach the target amount.

### BRIEF DESCRIPTION OF DRAWINGS

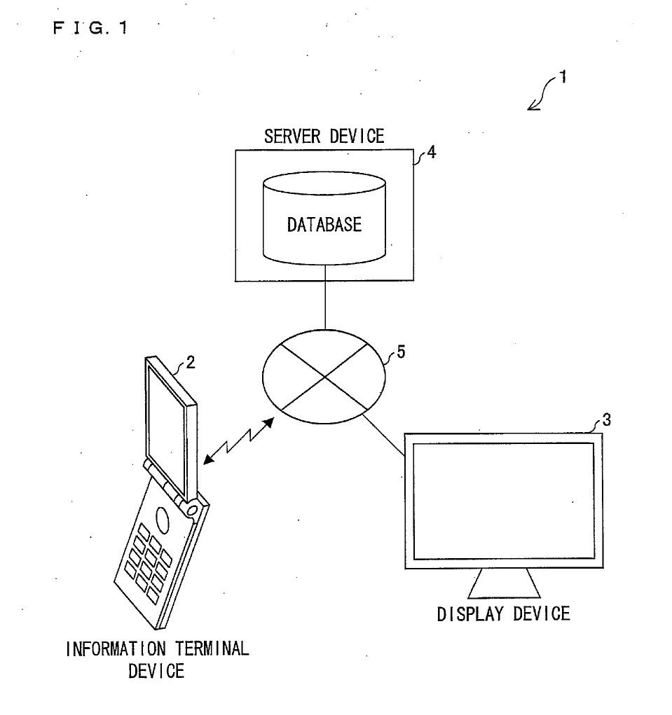

### FIG. 1

FIG. 1 is a schematic view illustrating a configuration of a calorie consumption assistance system according to one embodiment of the present invention.

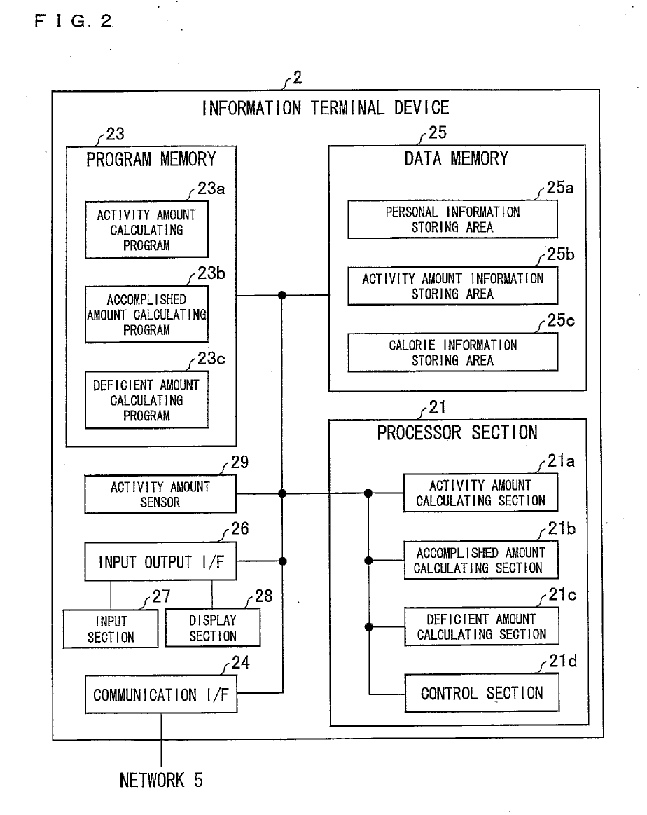

### FIG. 2

FIG. 2 is a block diagram illustrating a configuration of an information terminal apparatus according to the embodiment of the present invention.

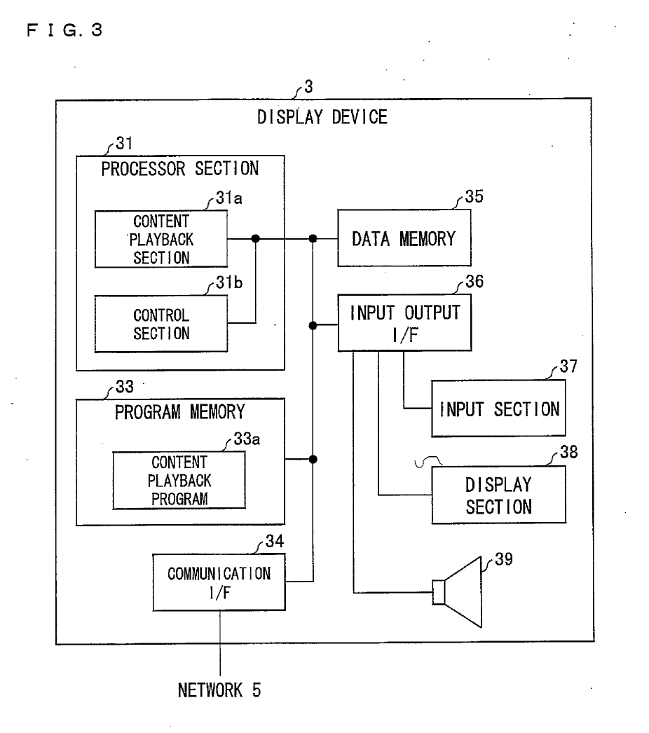

### FIG. 3

FIG. 3 is a block diagram illustrating a configuration of a display device according to the embodiment of the present invention.

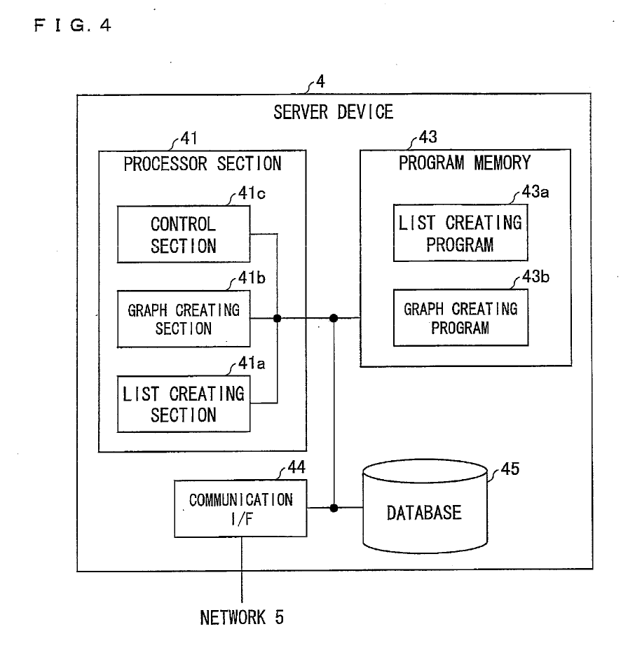

### FIG. 4

FIG. 4 is a block diagram illustrating a configuration of a server apparatus according to the embodiment of the present invention.

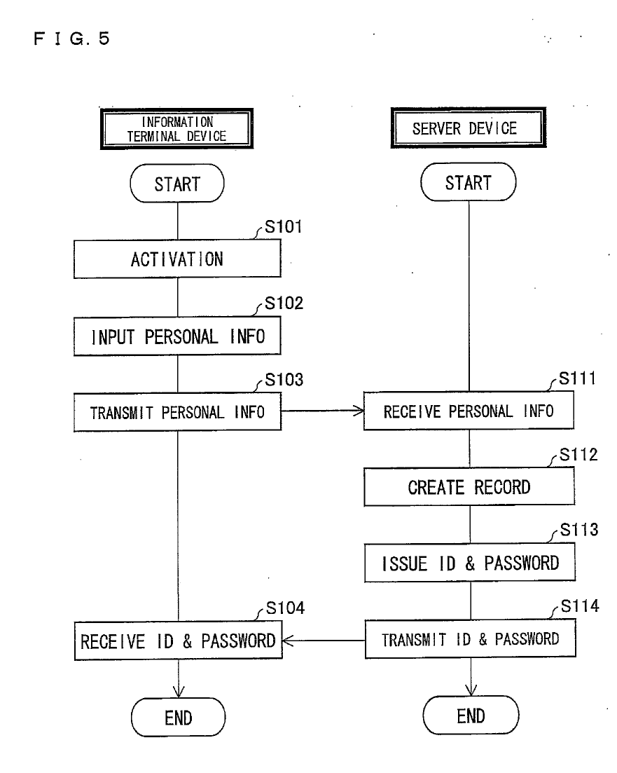

### FIG. 5

FIG. 5 is a flow chart illustrating steps of an initial setting operation of the calorie consumption assistance system according to the embodiment of the present invention.

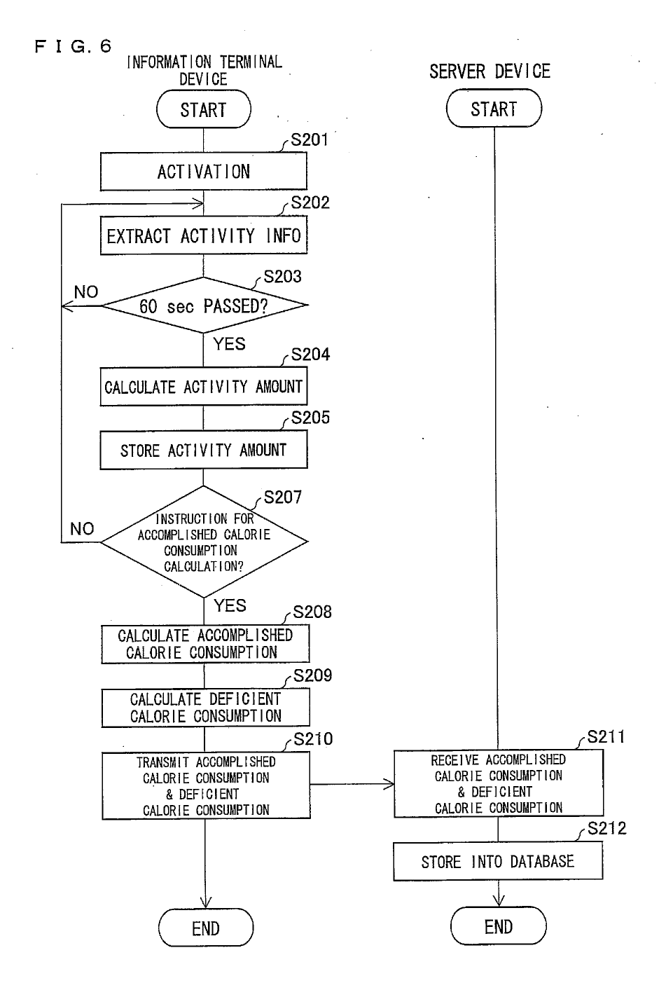

### FIG. 6

FIG. 6 is a flow chart illustrating steps of an operation for calculating out a deficient calorie consumption amount of a user in the calorie consumption assistance system according to the embodiment of the present invention.

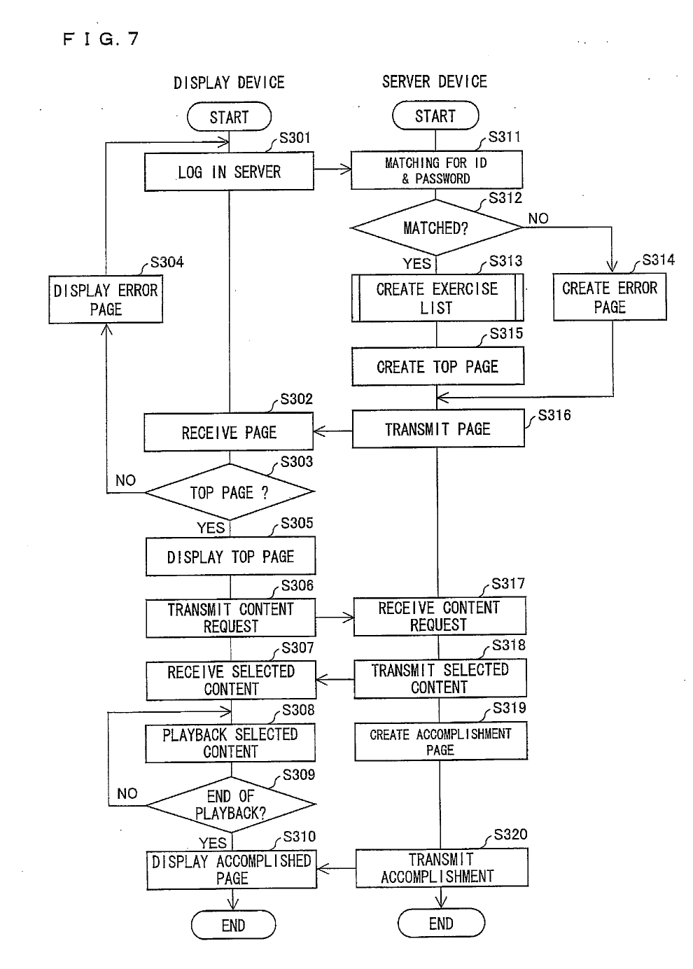

### FIG. 7

FIG. 7 is a flow chart illustrating steps of an operation for displaying an exercise content suitable for the deficient calorie consumption amount in the calorie consumption assistance system according to the embodiment of the present invention.

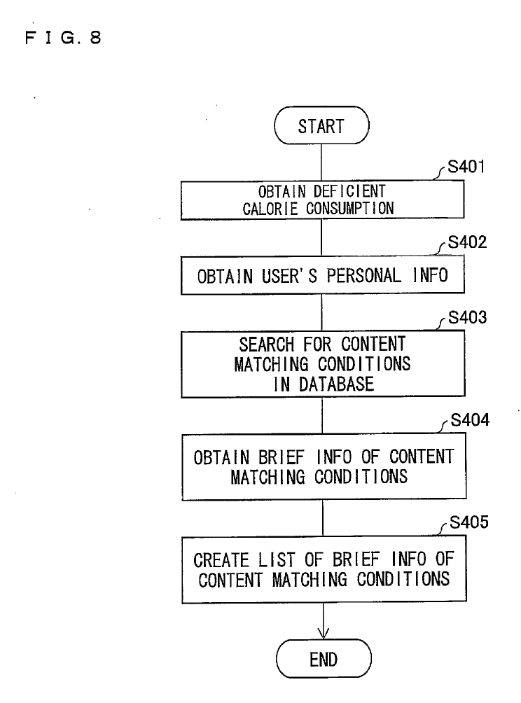

### FIG. 8

FIG. 8 is a flow chart illustrating steps of an operation for creating, in a server device, a list of brief information of exercise contents suitable for the deficient calorie consumption amount according to the embodiment of the present invention.

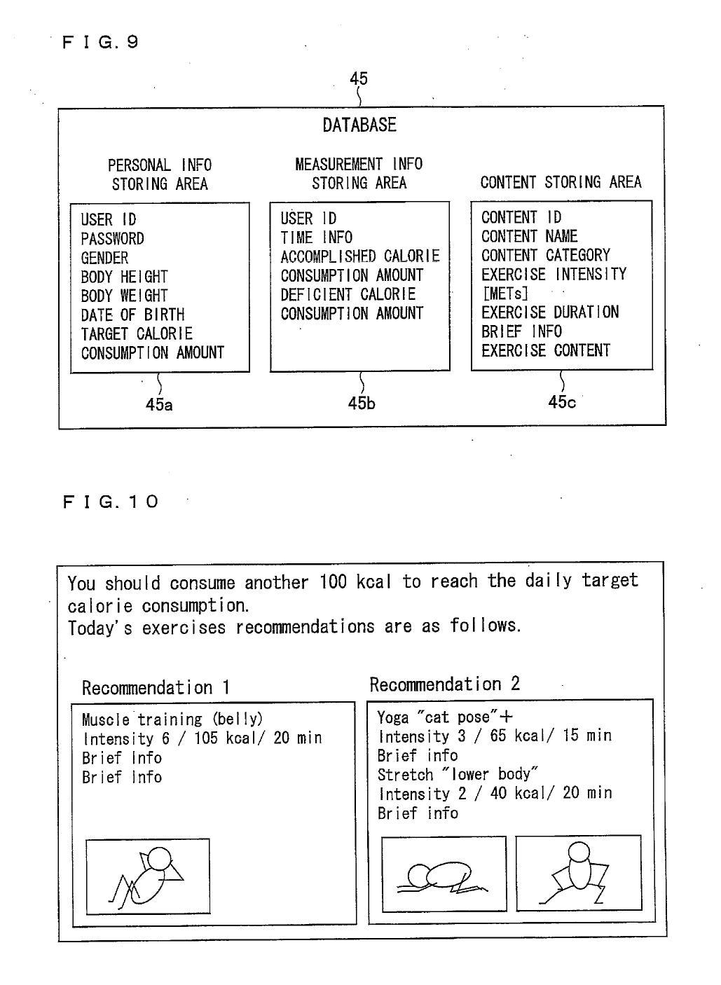

### FIG. 9

FIG. 9 is a block diagram illustrating an internal configuration of a database provided to the server device according to the embodiment of the present invention.

### FIG. 10

FIG. 10 is a schematic diagram of a configuration of a top page created by the server device according to the embodiment of the present invention.

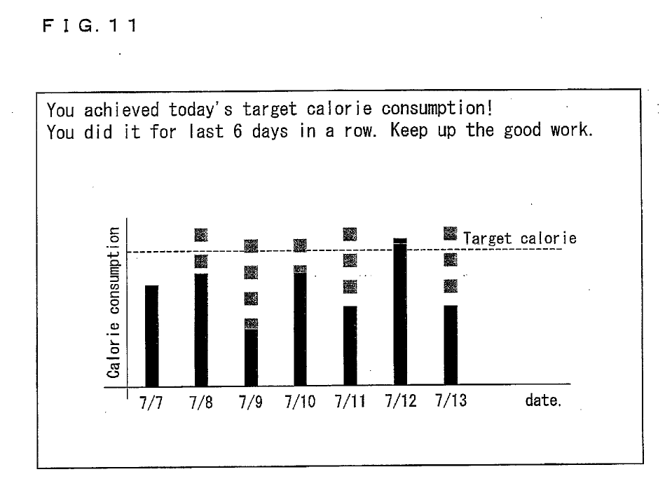

### FIG. 11

FIG. 11 is a schematic diagram of a configuration of an accomplishment page created by the server device according to the embodiment of the present invention.

### DESCRIPTION OF EMBODIMENTS

In the following, one embodiment of the present invention is described referring to drawings.

To begin with, described in outline is a configuration of a calorie consumption assistance system 1 according to the present invention referring to FIG. 1. FIG. 1 is a schematic view illustrating a configuration of a calorie consumption assistance system according to one embodiment of the present invention.

### Configuration of Calorie Consumption Assistance System 1

As illustrated in FIG. 1, a calorie consumption assistance system 1 includes an information terminal device (mobile terminal device) 2, a server device 4, a display device 3, and a network 5. The information terminal device 2 is configured to be carried by a user. The server device 4 includes a database configured to store a plurality of exercise contents (exercise assisting contents) therein. The display device 3 is configured to display an exercise content sent from the server device 4. The information terminal device 2, the server device 4 and the display device 3 are connected with each other via the network 5. The network 5 for connecting the information terminal device 2, the server device 4 and the display device 3 with each other may adopt any communication method, such as wireless communication, wired communication, the internet, etc., provided that these device can perform data communication between them. The exercise contents are contents indicating exercises for assisting user's calorie consumption. For example, the exercise contents show examples of exercises such as yoga, muscle training, stretching, running, jogging, cycling, fitness exercises, martial arts (Aikido, Karate, boxing, etc.), walking, fast walking, dancing, aerobics, jumping rope, radio gymnastic exercises, ball game exercises such as tennis, badminton, swimming, etc. Moreover, the exercise contents are constituted by a video file (such as H.264, MPEG2, etc.), a still image file (such as JPEG, GIF, etc.), a text file, and/or the like.

### Overview of Operation of Calorie Consumption Assistance System 1

In the following, how the calorie consumption system 1 is operated is described in overview. The information terminal device 2 calculates a calorie consumption amount (hereinafter, accomplished calorie consumption amount) consumed by a user in a certain time period, and calculates out a difference (hereinafter, deficient calorie consumption amount) by subtracting the accomplished calorie consumption amount from a calorie consumption amount (hereinafter, target calorie consumption amount) targeted to achieve in the certain time period by a user. The deficient calorie consumption amount thus calculated out by the information terminal 2 is sent to the server device 4. The server device 4 selects from the database an exercise content suitable for the deficient calorie consumption amount. The display device 3 obtains, from the server device 4, the exercise content suitable for the deficient calorie consumption amount, and displays the exercise content on a display section of the display device 3. The user can achieve the target calorie consumption amount by carrying out an exercise described on the exercise content displayed on the display section of the display device. Thereby, the user can solve short of exercise.

Compared with the conventional arts in which the deficiency of the calorie consumption to the target amount is solved only by walking, the calorie consumption assistance system 1 according to the present embodiment provides an exercise content suitable for the deficiency calorie amount. Thus, compared with the conventional arts, the calorie consumption assistance system 1 according to the present embodiment allows the user to solve the deficiency of the calorie consumption to the target amount via an efficient exercise other than walking. That is, the calorie consumption assistance system 1 according to the present embodiment is a system assisting the user in calorie consumption in such a manner that, when the user has not achieved the target calorie consumption amount, the calorie consumption assistance system 1 provides the user with an exercise content suitable to make up the deficiency of the calorie consumption to achieve the target amount, that is, an exercise content suitable for the deficient calorie consumption amount, so that the target calorie consumption can be achieved in the certain time period.

Next, internal configurations of the information terminal device 2, the display device 3, and the server device 4 provided to the calorie consumption assistance system 1 are described in order below.

### Configuration of Information Terminal Device 2

Firstly, the configuration of the information terminal device 2 provided to the calorie consumption assistance system 1 is described in more details below referring to FIG. 2. FIG. 2 is a block diagram illustrating the configuration of the information terminal apparatus 2 provided to the calorie consumption assistance system 1 according to the present embodiment.

As illustrated in FIG. 2, the information terminal device 2 includes a processor section 21, a program memory 23 for storing various programs for operations of the processor section 21, a data memory 25 for storing various data such as data provided via the network 5 and data created by the processor section 21, a communication interface 24 (hereinafter, communication I/F 24) for connecting to the network 5, an input section 27 (such as ten keys, a touch panel, or the like) for receive user's instructions, a display section 28 (such as a liquid crystal display panel) for displaying a content thereon, an input output I/F 26 for connecting the processor section 21 with the input section 27 and the display section 28, and an activity amount sensor 29. Moreover, the program memory 23 is configured to store an activity amount calculating program 23a, an accomplished amount calculating program 23b, and a deficiency amount calculating program 23c therein. The processor section 21 includes an activity amount calculating section 21a configured to operate based on the activity amount calculating program 23a, an accomplished amount calculating section 21b (calorie consumption amount determining means) configured to operate based on the accomplished amount calculating program 23b, a deficiency amount calculating section 21c configured to operate based on the deficiency amount calculating program 23c, and a control section 21d (target amount determining means, body information setting means).

The activity amount sensor 29 has a function of detecting acceleration of movement of the user carrying the information terminal device 2. More specifically, the activity amount sensor 29 has a function of measuring acceleration of upward, downward, rightward, leftward, frontward, and backward movements of the user. This allows the activity amount sensor 29 to detect physical activity of the user. The detection provides a detection result whose unit is “METs”. The “METs” is a unit indicating a ratio of an amount of energy consumed by an exercise or the like by a person and an energy consumed by the person during rest. That is, the “METs” is a unit indicating an intensity of the exercise. Moreover, by multiplying a time period of an exercise by “METs”, it is possible to calculate out the physical activity amount (whose unit is EX: 1[EX]=1[METs]×1 [hour]). As one method of calculating calorie consumption by using the physical activity amount (EX), it is known to use an Equation (1): Calorie consumption [kcal]=1.05×physical activity amount [EX]×body weight [kg]. Again in the present embodiment, the above Equation (1) is used to work out the calorie consumption amount that the user is to consume. For example, for a user of 60 kg in body weight, calorie consumption consumed by an exercise with a physical activity of 2 EX for 30 minutes=1.05×2 [EX]×0.5 [hour]×60 [kg]=63 [kcal].

Note that The present invention is not limited to the present embodiment, in which the activity amount sensor 29 detects acceleration and the user's physical activity (METs unit) is worked out based on the acceleration. In other words, the user's physical activity (METs unit) may be worked out based on any kind of physical amounts. For example, an angular speed of the user may be detected and the user's physical activity (METs unit) is worked out based on the angular speed.

### Configuration of Display Device 3

Next, the configuration of the display device 3 provided to the calorie consumption assistance system 1 is described below in more details referring to FIG. 3. FIG. 3 is a block diagram illustrating the configuration of the display device 3 provided to the calorie consumption assistance system 1 according to the present embodiment.

As illustrated in FIG. 3, the display device 3 includes a processor section 31, a program memory 33 for storing programs for operations of the processor section 31, a data memory 35 for string various data such as data provided via the network 5 or data created by the processor 31, a communication interface 34 (hereinafter, communication I/F 34) for connecting to the network 5, an input section 37 (such as ten keys, a touch panel, or the like) for receive user's instructions, a display section 38 (such as a liquid crystal display panel) for displaying a content thereon, and a speaker 39 for audio output. Moreover, the program memory 33 stores a content playback program 33a therein. The processor section 31 includes a control section 31b (display means) and a content playback section 31a (display means) operating based on the content playback program 33a.

### Configuration of Server Device 4

Next, the configuration of the server device 4 provided to the calorie consumption assistance system 1 is described below in more details referring to FIG. 4. FIG. 4 is a block diagram illustrating the configuration of the server device 4 provided to the calorie consumption assistance system 1 according to the present embodiment.

As illustrated in FIG. 4, the server device 4 includes a processor section 41, a program memory 43 for storing various programs for operations of the processor 41, a communication interface 44 (hereinafter, communication I/F 44) for connecting to the network 5, and a database 45 for storing data provided via the network 5 and a plurality of exercise contents therein. Moreover, the program memory 43 stores therein a list creating program 43a and a graph creating program 43b. The processor section 41 includes a control section 41c (content selecting means), a list creating section 41a (candidate content selecting means) operating based on the list creating program 43a, and a graph creating section 41b operating based on the graph creating program 43b.

### Initial Setting Operation

Before using the calorie consumption assistance system 1 according to the present embodiment, the user of the calorie consumption assistance system 1 registers his/her personal information on the information terminal device 2 and the server 4 and performs initial setting in the information terminal device 2.

In the following, the initial setting operation in the calorie consumption assistance system 1 is described referring to FIG. 5. FIG. 5 is a sequence diagram illustrating steps of the initial setting operation in the calorie consumption assistance system 1.

As illustrated in FIG. 5, the input section 27 of the information terminal device 2 receives from the user an instruction for activating the information terminal device 2 (such as an instruction for turning ON the information terminal device 2). Then, the control section 21d activates an application of the information terminal device 2 (Step 101: hereinafter, abbreviated as S101). Then, for the initial setting operation of the information terminal device 2, the input section 27 receives user's personal information including body information and a target amount of calorie consumption, and the control section 21d stores the inputted personal information in a personal information storing area 25a (S102). The operation at S102 allows the control section 21d to set the target calorie consumption amount according to the target amount of calorie consumption thus inputted by the user.

As well as the storing of the personal information in the personal information storing area 25a, the control section 21d also transmits the personal information to the server device 4 via the communication I/F 24 (S103). The server device 4 receives the personal information via the communication I/F 44 from the information terminal device 2 (S111). The control section 41c of the server device 4 stores in the database 45 the personal information received via the communication I/F 44, and creates a record of the personal information therein (S 112). Further, the control section 41c creates an identification information (hereinafter, user ID) for the personal information recorded in the database 45 at S112, and creates a password associated with the identification information. The identification information is information to distinguish the personal information of one user to the personal information of the other user. Then, the control section 41c stores in the database 45 the user ID and password in association with the personal information (S113). The control section 41c sends the created user ID and password to the information terminal device 2 via the communication I/F 44 (S114).

The information terminal device 2 receives the user ID and password from the server device 4 via the communication I/F 24. Then, the control section 21d stores the received user ID and password in the personal information storage area 25a in association with the personal information stored therein (S104).

The initial setting operation of the calorie consumption assistance system 1 is completed when it is achieved that the information terminal device 2 and the server device 4 store (i) the personal information of the user carrying the information terminal device 2, and (ii) the user ID and password associated with the personal information.

The personal information of the user in the present embodiment is constituted by (i) the body information including gender information, body height, body weight, and birth date of the user, and (ii) the target amount of the calorie consumption. However, the personal information may include other information such as an address, name, occupation, family structure, favorites, etc. of the user. Further, the present embodiment is arranged such that the control section 21d of the information terminal device 2 determines the target calorie consumption amount according to the input amount inputted by the user. However, it may be arranged such that the control section 21d of the information device 2 determines the target calorie consumption amount according to the birth date, body height, or body weight of the user inputted by the user.

### Calculating Operation of Deficient Calorie Consumption Amount

Next, the calculating operation of the deficient calorie consumption amount of the information terminal device 2 is described referring to FIG. 6. FIG. 6 is a flow chart illustrating steps of an operation for calculating out the deficient calorie consumption amount of the user by the information terminal device 2, and steps of an operation of receiving the deficient calorie consumption amount by the server device 4.

As illustrated in FIG. 6, the input section 27 of the information terminal device 2 receives from the user an instruction of turning ON the information terminal device 2. then, the control section 21d activates an application of the information terminal device 2 (S201). Further, the activity amount calculating section 21a reads out the activity amount calculating program 23a from the program memory 23. The accomplished amount calculating section 21b reads out the accomplished amount calculating program 23b from the program memory 23. The deficient amount calculating section 21c reads out the deficient amount calculating program 23c from the program memory 23.

After the application of the information terminal device 2 is activated, the activity calculating section 21a extracts measured amounts of a physical activity amount via the activity amount sensor 29 (S202). The physical activity amount is an amount indicating the physical activity of the user. The physical activity amount is on the unit of “METs” as described above. The activity amount calculating section 21a measures a time period from start of extraction of the physical activity amount of the user, and judges whether or not the time period reaches 60 seconds (S203). The activity amount calculating section 21a repeats the extraction until the time period reach 60 seconds. When the activity amount calculating section 21a detects that the time period exceeds 60 seconds, the activity amount calculating section 21a carries out an operation of S204.

The activity amount calculating section 21a averages the measured amounts, thus extracted at S202, of the physical activity amount for the time period of 60 seconds (S204). Further, the activity amount calculating section 21a stores, as a physical activity amount, the average of the measured amounts of the physical activity amount in an activity amount information storing area 25b (S205).

After the activity amount calculating section 21a completes the operation at S205, the control section 21d judges whether the input section 27 has received from the user an instruction of calculating out the accomplished calorie consumption amount (S207).

At S207, if the input section 27 has not received the instruction of calculating out the accomplished calorie consumption amount, the activity amount calculating section 21a goes to the operation of S202. That is, the physical activity amounts of every 60 seconds are accumulated in the activity amount information storing area 25b until the input section 27 receives the instruction of calculating out the accomplished calorie consumption amount.

On the other hand, if it is judged at S207 that the input section 27 receives the instruction of calculating out the accomplished calorie consumption amount, the accomplished amount calculating sections 21b reads out (i) all the physical activity amounts accumulated in the activity amount information storing area 25b, and (ii) the body weight of the user stored in the personal information storing area 25a. The accomplished amount calculating section 21b works out the accomplished calorie consumption amount, based on the physical activity amount and the user's body weight thus read out. More specifically, the accomplished amount calculating section 21b uses Equation (1) described above. That is, for each of all the physical activity amounts, the accomplished amount calculating section 21b multiplies the physical activity amount by the user's body weight and 1.05. Thereby, the accomplished amount calculating section 21b calculates out a total calories consumed by the user from the activation of the information terminal device 2 to the reception of the instruction of calculating out the accomplished calorie consumption amount, that is, the accomplished amount calculating section 21b calculates out the accomplished calorie consumption amount (S208). Further, the accomplished amount calculating section 21b obtains time information by a time control module (such as a real time clock or the like; not illustrated) provided to the information terminal device 2. The time information specifies the certain period and may be, for example, date if the time period is specified by date. Then, by the accomplished amount calculating section 21b, the time information thus obtained and the accomplished calorie consumption amount thus calculated out are stored in a calorie information storing area 25c in association with each other.

Next, the deficient amount calculating section 21c reads out from the personal information storing area 25a the target calorie consumption amount of the user. Then, by the deficient amount calculating section 21c, the accomplished calorie consumption amount thus calculated out at S208 is subtracted from the target calorie consumption amount thus read out, thereby obtaining a difference amount. Thus, the deficient calorie consumption amount calculating section 21c stores the difference amount (the deficient calorie consumption amount) in the calorie information storing area 25c (S209).

Then, the control section 21d reads out the user ID from the personal information storing area 25a and transmits the user ID to the server device 4 via the communication I/F 24 (S210) in such a manner than the user ID is transmitted in association with the time information, the accomplished calorie consumption amount, and the deficient calorie consumption amount stored in the calorie information storing area 25c at S208 and S209. The transmission by the control section 21d at S210 may be carried out at a predetermined timing (e.g., right after the operation at S209 is completed) or may be carried out in accordance with a user's instruction inputted via the input section 27.

The server device 4 receives the user ID, the time information, the accomplished calorie consumption amount, and the deficient calorie consumption amount via the communication I/F 44 from the information terminal device 2 (S211). Further, the control section 41c stores in the database 45 the time information, the accomplished calorie consumption amount, and the deficient calorie consumption amount thus received (S212).

In the present embodiment, the information terminal device 2 is arranged such that the physical activity amount of the user is calculated and stored every 60 seconds. However, the information terminal device 2 may be arranged such that the physical activity amount of the user is calculated and stored at other time intervals than 60 sections, for example, every 10 minutes or every 30 seconds.

Moreover, in the present embodiment, the information terminal device 2 is arranged such that the accomplished calorie consumption amount is calculated out by using the above Equation (1) from the physical activity amount (METs unit) obtained by the activity amount sensor 29. However, the present invention is not limited to this, and the information terminal device 2 may carry out the calculation of the accomplished calorie consumption amount in any way. One example of known alternative methods is such that the calorie consumption amount consumed by the user is calculated out from the number of steps of the user. The accomplished calorie consumption may be worked out by using this method. In the following, such an arrangement in which a pedometer is provided in replacement of the activity amount sensor 29 and the accomplished calorie consumption amount is calculated out from the number of steps, detected by the pedometer, of the user.

An information terminal device 2 includes a pedometer in replacement of the activity amount sensor 29. The control section 21d calculates out a walking distance [m] by multiplying (i) the number of steps, detected by the pedometer, of the user by (ii) a length of stride [m] of the user. Further, the user's walking distance [m] thus calculated out is divided by a walking speed (per minute) (which is generally 70 [m/min]) by the control section 21d. In this way a walking time [min] of the user is calculated out. The length of stride of the user may be set by the user inputting his/her length of stride into the information terminal device 2. As one alternative, the control section 21d may calculate out the length of stride from the use's body height inputted by the user at S102 (see FIG. 5).

As one parameter to calculate out calorie consumption, the following Equations (2) and (3) are well known:

Estimated oxygen uptake at walking [ml/kg/min]=Oxygen uptake at rest 3.5 [ml/kg/min]+0.1×speed per minute [m/min] (2),

Energy consumption per 1 liter of oxygen uptake=5 [Kcal/l] (3).

From Equation (2), the estimated total oxygen uptake of the user during walking [ml] can be worked out from the following Equation (4) derived from Equation (2):

Estimated total oxygen uptake during walking [ml]=oxygen uptake at rest 3.5 [ml/kg/min]×body weight [kg]×walking time [min]+0.1×speed per minutes 70 [m/min]×body weight [kg]×walking time [min] (4).

Further, the calorie consumption amount of the user at walking can be obtained by the following Equation (5) derived from Equations (3) and (4):

Calorie consumption amount at walking [Kcal]=Estimated total oxygen uptake during walking [ml]×5 [Kcal/l]×0.001 (5).

By using Equation (5), the user's stride [m] thus calculated, and user's walking time [min], the control section 21d calculates out the calorie consumption amount consumed by the user at walking (hereinafter, this amount is referred to as walking calorie consumption amount). That is, the control section 21d can calculates out the walking calorie consumption amount by using the following Equation (6):

Walking calorie consumption amount [Kcal]=3.5×body weight [kg]×(number of steps×length of stride [m])/70)+0.1×70×body weight [kg]×(number of steps×length of stride [m])/70)×5×0.001 (6).

Further, the control section 21d calculates out calorie consumption amount of the user not at walking (hereinafter, this amount is referred to as not-at-walking calorie consumption amount). More specifically, the control section 21d measures the time in a time period from the activation of the information terminal device 2 to the reception of the instruction of calculating the accomplished calorie consumption from the user. The control section 21d calculates out the not-at-walking time [min] by subtracting the walking time from the time thus measured in the time period. Further, the control section 21d calculates out not-at-walking calorie consumption amount from the not-at-walking time [min] thus calculated out, the oxygen uptake at rest 3.5 [ml/kg/min], the user's body weight [kg], and the energy consumption amount per 1 liter of oxygen uptake 5[Kcal/l]. That is, the control section 21d can calculates out the not-at-walking calorie consumption amount by the following Equation (7):

Not-at-walking calorie consumption amount [Kcal]=3.5 (ml/kg/min)×not-at-walking time [min]×body weight [kg]×5 [Kcal/l]×0.001 (7).

Moreover, the control section 21d may calculate out the not-at-walking calorie consumption amount by using the physical activity amount at rest 1[EX]=1[METs]×1 [hour], the user's body weight [kg], and the not-at-walking time [min]. In other words, the control section 21d may calculate out the not-at-walking calorie consumption amount by using the following Equation (8):

Not-at-walking calorie consumption amount=1[EX]×body weight [kg]×not-at-walking time [min]/60.

By adding up the walking calorie consumption amount and the not-at-walking calorie consumption amount thus calculated, the control section 21d works out the accomplished calorie consumption amount, that is, the calorie consumption actually consumed by the user from the activation of the information terminal device 2 and the reception of the user's instruction of calculating the accomplished calorie consumption amount.

Note that the present invention is not limited to the above arrangement in which the information terminal device 2 includes the pedometer. A pedometer may be provided as an external device in association with the information terminal device 2, so that the information terminal device 2 obtains the number of steps of the user from the pedometer externally.

### Configuration of Various Data Stored In Database 45

Next, described referring to FIG. 9 is the configuration of various data stored in the database 45 in the server 4 after the initial setting operation (S101 to S114 in FIG. 5) and the deficient calorie consumption calculating operation (S201 to S210 in FIG. 6). FIG. 9 is a view explaining the configuration of the various data stored in the database 45.

As illustrated in FIG. 9, the database 45 includes a personal information storing area 45a, a measurement information storing area 45b, and a content storing area 45c. The personal information storing area 45a is an area for storing personal information transmitted from the information terminal device 2 in the initial setting operation. The measurement information storing area 45b is an area for storing the user ID, the time information, the accomplished calorie consumption and the deficient calorie consumption amount, transmitted from the information terminal device 2 in the deficient calorie consumption amount calculating operation. The content storing area 45c is an area for storing a plurality of exercise contents.

The content storing area 45c stores the plurality of exercise contents respectively in association with their information such as contents ID unique to the exercise contents, their content names, their content categories (indicating categories of the exercise contents), their exercise intensities (unit: METs), their exercise duration, and their brief information (e.g., still images of the exercise contents), etc.

The present invention is not limited to the present embodiment, in which the database 45 of the server 4 stores the plurality of exercise contents. The present invention may be arranged such that another storing device connected to the server device 4 via a network stores the plurality of exercise contents. In this arrangement, the database 45 of the server device 4 stores, instead of storing the exercise contents therein, description indicating where information resources (text, image, or the like constituting the exercise contents) are on the Internet. The description may be URL or tag of the another storing device in which the plurality of exercise contents are stored. The server device 4 refers to the description of the location of information resources, so as to obtain an exercise content stored in the another storing device.

### Playback of Exercise Content

Next, described referring to FIG. 7 are (i) an operation of the server device 4 for obtaining from the content storing area 45c an exercise content suitable for the deficient calorie consumption amount, and (ii) an operation of the display device 3 for providing to the user the exercise content suitable for the deficient calorie consumption amount. FIG. 7 is a flowchart of the operations of the display device 3 and server device 4 in relation to the providing the exercise content. In the calorie consumption assistance system 1 of the present embodiment, the server device 4 should have received the deficient calorie consumption amount from the information terminal device 2, in order for the calorie consumption assistance system 1 to provide the user with an exercise content suitable for the deficient calorie consumption amount. Therefore, the operation in FIG. 7 is on such a premise that the server device 4 has stored the deficient calorie consumption of the user in the database 45 of the server device 4.

The user inputs his/her user ID and password via the input section 37 of the display device 3, so as to log in a web site linked to the server device 4. The control section 31b of the display device 3 transmits the inputted user ID and password to the server device 4 via the communication I/F 34 (S301).

The server device 4 receives the user ID and password from the display device 3 via the communication I/F 44. Then, by the control section 41c the user ID and password received from the display device 3 are compared with the user ID and password stored in the personal information storing area 25a (S311).

Next, the control section 41c judges whether or not the received password and the password stored in the personal information storing area 25a are matched with each other as a result of the comparison at S311 (S312). If the two passwords do not match with each other at S312, the control section 41c creates an error page for notifying the user that the user ID and the password inputted by the user are not correct (S314). Moreover, instead of creating a new error page, S314 may be arranged such that the control section 41c obtains a file of a message text from the database 45 as an error page, which file is stored in the database 45 in advance, and which message text reads, for example, “the user ID an password are not correct”.

If the two passwords match with each other at S312, the list creating section 41a creates a content list according to the deficient calorie consumption amount associated with the user ID received at S311 (S313). The content list lists up exercise contents suitable for the deficient calorie consumption amount. The operation at S313 is described in more details below.

Next, the control section 41c creates a top page by using (i) the deficient calorie consumption amount stored in the measurement information storing area 45b, and (ii) the content list created at S313. The configuration of the top page created by the control section 41c will be described in more details later.

The control section 41c transmits the error page or the top page to the display device 3 via the communication I/F 44, the error page being created at S314 and the top page being created at S315. The display device 3 receives the error page or top page from the server device 4 via the communication I/F 34 (S302).

The control section 31b judges whether the page received via the communication I/F at S302 is an error page or a top page (S303). If the page received via the communication I/F 34 at S302 is an error page, the control section 31b provides the error page to the display section 38 via an input output I/F 36 and causes the display section 38 to display the error page thereon (S304). On the other hand, if the page received via the communication I/F 34 at S302 is a top page, the control section 31b provides the top page to the display section 38 via an input output I/F 36 and causes the display section 38 to display the top page thereon (S305).

On the top page displayed on the display section 38, brief information of at least one exercise content suitable for the deficient calorie consumption amount is displayed. From among the brief information displayed on the top page, the user selects, via the input section 37, an exercise that the user will do. The control section 31b detects the content ID of the brief information selected by the user via the input section 37. Then, the control section 31b sends the detected content ID to the server device 4 via the communication I/F 34 as a content request (S306).

The server device 4 receives the content ID from the display device 3 via the communication I/F 44 (S317). Then, from the content storing area 45c of the database 45, the control section 41c reads out the exercise content indicated by the content ID thus received, in other words, the control section 41c reads out the exercise content selected by the user (hereinafter, this content is referred to as “selected content”), and transmits the selected content to the display device 3 via the communication I/F 44 by, for example, streaming or the like (S318). Further, the control section 41c calculates out a calorie consumption amount (hereinafter, referred to as content calorie consumption amount (assisted calorie consumption amount)) that the user would consume in case the user performs the selected content transmitted to the display device 3. Then, the control section 41c stores in the measurement information storing area 45b of the database 45 the content calorie consumption amount in association with a latest deficient calorie consumption amount. The content calorie consumption amount is calculated out by an equation: Content calorie consumption amount=Exercise intensity of the selected content×Exercise duration of the selected content×User's body weight×1.05. After the control section 41c transmits the selected content to the display device 3, the graph generating section 41b creates an accomplishment page in association with the user ID received at S311 (S319). The graph generating section 41b transmits the created accomplishment page to the display device 3 via the communication I/F 44 (S320). The accomplishment page will be described later in more details on its configuration and how to create it.

On the other hand, the display device 3 receives the selected content from the server 4 via the communication I/F 34 (S307). Next, the content playback section 31a causes the display section 38 to display the selected content by streaming etc. if the selected content received via the communication I/F 34 is a video image (S308). Further, if the selected content is associated with sounds, the content playback section 31a causes a speaker 39 to output the sounds.

The content playback section 31a detects whether the display of the selected content is finished or not (S309). If yes, the control section 31b causes the display section 38 to display the accomplishment page transmitted from the server device at S320 (S310).

### Operation At S313

In the following the operation of the server device 4 at S313 is described referring to FIG. 8. Referring to the user ID received from the display device 3 at S311(see FIG. 7), the list creating section 41a reads out the latest deficient calorie consumption amount associated with the user ID from the measurement information storing area 45b of the database 45 (S401). Next, the list creating section 41a reads out the personal information of the user associated with the user ID, more specifically, the body weight of the user, from the personal information storing area 45a of the database 45 (S402). Based on the deficient calorie consumption amount thus read out and the personal information, the list creating section 41a searches for candidate exercise contents (i.e., candidates for contents to be provided to the user via the display device 3) among the plurality of exercise contents stored in the database 45, and then, selects, as the candidate exercise contents, at least one exercise content from among the plurality of exercise contents stored in the database 45 (S403). More specifically, the selection of the candidate exercise contents is carried out as follows. The plurality of exercise contents are stored respectively in association with their exercise intensity (METs unit) and exercise duration in the content storing area 45c. Then, from among the plurality of exercise content stored in the content storing area 45c, the list creating section 41a selects an exercise content(s) that satisfies a condition that deficient calorie consumption amount exercise intensity (METs)×exercise duration×user's body weight×1.05. Note that the present invention is not limited to the present embodiment, in which the user's body weight is used to select the exercise content suitable for the deficient calorie consumption amount. The present invention may be arranged such that the content storing area 45c stores, in advance, the exercise contents respectively in association with estimated calorie consumption amounts that a person with a standard body weight would consume when the person performs the exercises, and the list creating section 41a selects an exercise content suitable for the deficient calorie consumption amount by referring to the calorie consumption amounts stored in advance, that is, without considering the user's body weight.

Next, the list creating section 41a obtains, from the content storing area 45c, brief information (content name, content category, exercise intensity, exercise duration, still image of the exercise content, etc.) (S404), and creates a list of the brief information thus obtained (S405).

### Top Page

Next, the configuration of the top page created by the control section 41c at S315 (see FIG. 7) is described referring to FIG. 10. FIG. 10 is a schematic diagram illustrating one example of the configuration of the top page.

As illustrated in FIG. 10, the top page includes the deficient calorie consumption amount (100 kcal in FIG. 10) obtained at S401 (FIG. 8), and the brief information of the exercise content suitable for the deficient calorie consumption amount. Moreover, if a plurality of exercise contents are suitable for the deficient calorie consumption amount, the top page is configured such that the brief information of each exercise content can be displayed individually, for example, by labeled as “Recommendation 1”, “Recommendation 2”, as illustrated in FIG. 10. Further, in the present embodiment, the top page is configured such that the contents of the exercise contents are displayed on a sub-window as the still images of the exercise contents or part of moving images of the exercise contents by streaming. Moreover, a combination of the exercise contents suitable for the deficient calorie consumption amount may be presented as illustrated in “Recommendation 2” for the exercise contents in FIG. 10.

In the present embodiment, the deficient calorie consumption amount is displayed in the same font as the other text. However, the deficient calorie consumption amount is displayed in different font from that of the other text. More specifically, the deficient calorie consumption amount may be displayed with characters larger than these of the other text, or in a color different from that of the other text. By displaying the deficient calorie consumption amount differently from the other text on the top page, it becomes possible to let the user more strongly recognize the calorie amount he/she should consume. As a result, the calorie consumption assistance system according to the present invention can let the user to more strongly recognize necessity to perform the exercise content displayed on the top page. Moreover, the deficient calorie consumption amount may be displayed on the top page in such a manner that the deficient calorie consumption amount is displayed with different font sizes according to how large the deficient calorie consumption amount is. For example, it may be arranged such that a deficient calorie consumption amount less than 200 kcal is displayed with a relatively small font size, and a deficient calorie consumption amount not less than 200 kcal is displayed with a relatively large font size. Moreover, the top page may be such that a text brought to user's attention is displayed in a larger font than the other text. For example, a wording “200 kcal” indicating the deficient calorie consumption, or a wording “deficient” indicating that the user's accomplished calorie consumption amount has not reached the targeted calorie consumption amount may be displayed in a larger font than the other text.

### Accomplishment Page

Next, the configuration of the accomplishment page created by the graph creating section 41b at S319 (see FIG. 7) and how to create the accomplishment page are described referring to FIG. 11. FIG. 11 is a schematic diagram illustrating one example of the configuration of the accomplishment page.

From the measurement information storing area 45b of the database 45, the graph creating section 41b obtains the time information, accomplished calorie consumption amount, and content calorie consumption amount of every certain time periods in reference to the user ID obtained at S311 (see FIG. 7), the time information, accomplished calorie consumption amount, and content calorie consumption amount being associated with the user ID.

Based on the time information, accomplished calorie consumption amount, and content calorie consumption amount thus obtained, the graph creating section 41b creates, for the accomplishment page, a graph that can be visually presented to the user as illustrated in FIG. 11, the graph plotting the accomplished calorie consumption amount and content calorie consumption amount over time (on the basis of the certain time periods, e.g., daily basis in FIG. 11). The graph presentation is not limited to the present embodiment in which the accomplished calorie consumption amount and the content calorie consumption amount on the daily basis are indicated by different kinds of lines with different colors (the solid line for the former and the dotted line for the latter in the example of FIG. 11). For example, the graph may be presented in such a manner that the accomplished calorie consumption amount and the content calorie consumption amount are indicated weekly basis or monthly basis. Moreover, the accomplished calorie consumption amount and the content calorie consumption amount may be indicated integrally, in other words, a sum of the accomplished calorie consumption amount and the content calorie consumption amount may be indicated. Further, as an alternative, the accomplishment page may present the accomplished calorie consumption amount and the content calorie consumption amount in the other way than graphing. For example, the accomplishment page may present a list of the accomplished calorie consumption amount and the content calorie consumption amount.

In the present embodiment, the content calorie consumption amount is worked out by multiplying the exercise intensity of the selected content, exercise duration, user's body weight and the coefficient of 1.05. However, the present invention may be arranged such that the user carries the information terminal device 2 while performing the exercise of the selected content displayed on the display section 38 of the display device 3, so that the information terminal device 2 measures the calorie consumption amount consumed by performing the exercise of the selected content, and transmits the measured calorie consumption amount to the server device 4 as the content calorie consumption amount. With this arrangement, the accomplishment page created at S319 (see FIG. 7) is created with a calorie consumption amount actually consumed by the user, thereby being able to present to the user a more exact calorie consumption amount consumed by the user.

### Modification of Calorie Consumption Assistance System 1

The embodiment described above is to describe merely one example of the internal configurations of the information terminal device 2, the display device 3, and server device 4. The present invention encompasses embodiments in which one of the information terminal device 2, the display device 3, and server device 4, or a device(s) other than these devices is provided with part or all of the sections and functions of the other one of these devices.

As one specific example, the calorie consumption assistance system according to the present invention may be configured such that the display device 3 includes all the sections or functions of the server device 4, so that the calorie consumption assistance system does not include the server device 4.

As another example, the calorie consumption assistance system according to the present invention may be configured such that the server device 4 includes an accomplished amount calculating section 21b and a deficient amount calculating section 21d, and calculates out an accomplished calorie consumption amount and a deficient calorie consumption amount from a user's physical activity amount transmitted from the information terminal device 2.

As still another example, the calorie consumption assistance system according to the present invention may be configured such that the information terminal device 2 includes the content playback section 31a and its function of the display device 3 and the display section 28 of the information terminal device 2 displays the selected content, error page, top page, and accomplishment page.

The calorie consumption assistance system 1 of the present embodiment may be configured such that the server device 4 creates image data of the error page and the top page, and the display section 38 of the display device 3 displays the error page and the top page based on the image data. However, the present invention may be configured such that the server device 4 creates audio data in replacement of the error page and top page, and the speaker 39 the display device 3 outputs the audio data, thereby notifying the user that the user ID or the password does not match with the stored counterpart, or notifying the user of an exercise content suitable for the deficient calorie consumption amount.

### Program And Recording Medium

Blocks of the information terminal devices 2, display device 3, and the server device 4, more specifically, the processor section 21 of the information terminal device 2, the processor section 31 of the display device 3, and the processor section 41 of the server device 4 may be realized by way of hardware logic, or software as executed by CPUs (Central Processing Units) as follows.

The processor sections 21, 31, and 41 each include a

CPU (central processing unit) for executing instructions in a program (calorie consumption assistance program) realizing the functions, and a memory device (memory medium) such as a ROM (read only memory) which contains the program, a RAM (random access memory) to which the program are loaded in an executable form, a memory containing the program and various data, etc. With this configuration, the object of the present invention can be achieved by a certain recording medium.

The recording medium stores, in a computer-readable manner, software for realizing the function, that is, a program code (executable program, intermediate code program, or source program) of a program for the processor section 21, 31, or 41. To the processor section 21, 31, or 41, the recording medium is provided. The processor section 21, 31, or 41 as a computer (or CPU or MPU) reads and executes the program code stored in the recording medium provided thereto.

The recording medium provided to the processor section 21, 31, or 41 is not limited to a particular structure or kind. Examples of such a storage medium include tapes, such as magnetic tapes and cassette tapes; magnetic disks, such as floppy (registered trademark) disks and hard disks; and other discs, such as CD-ROMs, magneto-optical discs (MOs), mini discs (MDs), and digital video discs (DVDs). In addition, the storage medium may be a card, such as an IC card or an optical card; a semiconductor memory, such as a mask ROM, an EPROM, an EEPROM, or a flash ROM; or a memory provided inside a CPU or other computing means.

Moreover, the object of the present invention can be achieved by arranging such that the processor sections 21, 31, and 41 are connectable with each other via a communication network. In this case, the program code is supplied to the processor sections 21, 31, or 41 via the communication network. The communication network is not limited to a particular kind or a particular configuration, provided that the program code can be supplied to the processor sections 21, 31, or 41 via the communication network. The communications network may be, for example, the Internet, an intranet, extranet, LAN, ISDN, VAN, CATV communications network, virtual dedicated network (virtual private network), telephone line network, mobile communications network, or satellite communications network.

The transfer medium which makes up the communications network is not limited to particular configuration or kind. The transfer medium may be, for example, wired line, such as IEEE 1394, USB (Universal Serial Bus), electric power line, cable TV line, telephone line, or ADSL (Asymmetric Digital Subscriber Line); or wireless, such as infrared radiation (IrDA, remote control), Bluetooth (Registered Trademark), 802.11 wireless, HDR, mobile telephone network, satellite line, or terrestrial digital network. The present invention encompasses a computer data signal embed in a carrier wave, in which the program code is embodied electronically.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The calorie consumption assistance system according to the present invention may be configured as follows.

### First Configuration

A calorie consumption assistance system comprising: a portable terminal device; a server device; and a display device.

### Second Configuration

The calorie consumption assistance system as set forth in the first configuration, wherein:

the information terminal device includes:

activity amount measuring means for measuring activity amount;

accomplished calorie consumption calculating means for calculating accomplished calorie consumption from the activity amount thus measured by the activity amount measuring means;

target calorie consumption input means for inputting the target calorie consumption; and

storing means for storing the target calorie consumption inputted by the target calorie consumption input means,

the information terminal device calculating deficient calorie consumption from a difference between the target calorie consumption and the accomplished calorie consumption.

### Third Configuration

The calorie consumption assistance system as set forth in the first configuration, wherein:

the server terminal device includes a database,

the database storing:
a personal information table including a user ID, a password, gender information, a body height, a body weight, a birth date, and target calorie consumption;
a measurement information history table including the user ID, a measurement date, accomplished calorie consumption, and deficient calorie consumption; and
an exercise content table including a content ID, a content name, a content category, exercise intensity, exercise duration, brief information, and URL.

### Fourth Configuration

The calorie consumption assistance system as set forth in the first configuration, wherein:

the server terminal device includes:

means for calculating out a physical activity amount from the exercise intensity and exercise duration of the exercise content;

means for calculating calorie consumption from the body weight data and the physical activity amount; and

searching means for searching for an exercise content equivalent to the deficient calorie consumption from a result of the calorie consumption calculation,

the server terminal device performing list creation for creating a list from a result of the searching.

### Fifth Configuration

The calorie consumption assistance system as set forth in the first configuration, wherein:

the server device terminal performs graph creation for creating a graph for visually showing a difference between a physical activity amount in a daily life in a certain time period and the physical activity amount caused by the exercise content in the certain time period.

### INDUSTRIAL APPLICABILITY

The present invention provides a calorie consumption assistance system capable of assisting a user to efficiently achieve a targeted calorie consumption amount, and is especially applicable to health management/health care service using a portable phone.

### REFERENCE SIGNS LIST

1 Calorie consumption assistance system

2 Information terminal device (portable terminal device)

3 Display device

4 Server device

21a Activity amount calculating section

21b Accomplished amount calculating section
(Calorie consumption amount determining means)

21c Deficient amount calculating section

21d Control section
(Target amount deciding means, Body information setting means)

31a Content playback section (Display means)

31b Control section (Display means)

41a List creating section
(Candidate content selecting means)

41b Graph creating section

41c Control section (Content selecting means)

45 Database

1. A calorie consumption assistance system, comprising:
a portable terminal device including an activity amount sensor for detecting intensity of user's exercise, and calorie consumption amount determining means for determining, based on a result of detection of the activity amount sensor, a calorie consumption amount consumed by a user in a certain period and target amount deciding means for deciding a target amount of calorie consumption in the certain time period;
a server device including content selecting means for selecting an exercise assistance content suitable for a difference between the calorie consumption amount thus determined and the target amount thus decided, the exercise assistance content expressing an exercise for assisting user's calorie consumption; and
a display device including display means for displaying the exercise assistance content thus selected.

2. A calorie consumption assistance system as set forth in claim 1, comprising:
candidate content selecting means for selecting at least one exercise assistance content suitable for the difference, the at least one exercise assistance content being a candidate of the exercise assistance content that is to be selected by the content selecting means;
the display means displaying each brief information of the at least one exercise assistance content selected by the candidate content selecting means, and
the content selecting means selecting an exercise assistance content of brief information designated by the user from the each brief information thus displayed.

3. A calorie consumption assistance system as set forth in claim 1, wherein:
the display means displays the calorie consumption amount of every certain time period and an assisted calorie consumption amount of every certain time period, the assisted calorie consumption amount being a calorie consumption consumed by performing the exercise assistance content selected by the content selecting means.

4. A calorie consumption assistance system as set forth in claim 1, wherein:
the content selecting means performing the selection of the exercise assistance content suitable for the difference by selecting, from among a plurality of exercise assistance stored in a database, the exercise assistance content in reference with each assisted calorie consumption amount of the plurality of exercise assistance content,
the database storing the plurality of exercise assistance contents in association with the assisted calorie consumption amounts of the plurality of exercise assistance content, each assisted calorie consumption amount of an exercise assistance content being a calorie consumption consumed by performing the exercise assistance content.

5. A calorie consumption assistance system as set forth in claim 1, comprising:
body information setting means for setting body information of the user,
the content selecting means performing the selection of the exercise assistance content suitable for the difference by selecting, from among a plurality of exercise assistance stored in a database, the exercise assistance content in reference with the body information of the user, intensity information of exercises of the plurality of exercise assistance contents and exercise durations of the exercises,
the database storing the plurality of exercise assistance contents in association with the intensity information of exercises of the plurality of exercise assistance contents and the exercise durations of the exercises.

6. A calorie consumption assistance system, comprising:
calorie consumption amount determining means for determining a calorie consumption amount consumed by a user in a certain period;
target amount deciding means for deciding a target amount of calorie consumption in the certain time period;
content selecting means for selecting an exercise assistance content suitable for a difference between the calorie consumption amount thus determined and the target amount thus decided, the exercise assistance content expressing an exercise for assisting user's calorie consumption;
display means for displaying the exercise assistance content thus selected; and
body information setting means for setting body information of the user,
the content selecting means performing the selection of the exercise assistance content suitable for the difference by selecting, from among a plurality of exercise assistance stored in a database, the exercise assistance content in reference with the body information of the user, intensity information of exercises of the plurality of exercise assistance contents and exercise durations of the exercises,
the database storing the plurality of exercise assistance contents in association with the intensity information of exercises of the plurality of exercise assistance contents and the exercise durations of the exercises.

7. A calorie consumption assistance program for operating a computer provided to a calorie consumption assistance system as set forth in claim 1, the calorie consumption assistance program causing the computer to function as the means.

8. A computer-readable recording medium in which a calorie consumption assistance program as set forth in claim 7 is stored.
